(19) United States
(12) Patent Application Publication
(10) Pub. No.: US 2024/0034167 A1
(43) Pub. Date: Feb. 1, 2024

(54) COOLING ELEMENT FOR AN ELECTRIC CHARGING CABLE FOR AN ELECTRICAL ENERGY STORAGE DEVICE AND CORRESPONDING INSTALLATION METHOD

(71) Applicant: Valeo Systemes Thermiques, Le Mesnil-Saint-Denis (FR)

(72) Inventors: Yolanda Bravo, Zaragoza (ES); Jeremy Blandin, Le Mesnil-Saint-Denis Cedex (FR); Cédric De Vaulx, Le Mesnil-Saint-Denis Cedex (FR); Patrick Leblay, Le Mesnil-Saint-Denis Cedex (FR); Kamel Azzouz, Le Mesnil-Saint-Denis Cedex (FR); Julien Tissot, Le Mesnil-Saint-Denis Cedex (FR)

(73) Assignee: Valeo Systemes Thermiques, Le Mesnil-Saint-Denis (FR)

(21) Appl. No.: 18/257,513

(22) PCT Filed: Dec. 6, 2021
(86) PCT No.: PCT/EP2021/084436

§ 371 Date: Jun. 14, 2023

(30) Foreign Application Priority Data
Dec. 14, 2020 (FR) 2013177

(51) Int. Cl. B60L 53/302

(52) U.S. Cl. CPC B60L 53/302

(57) ABSTRACT

The invention relates to a cooling element (1) for an electric charging cable (2) for an electrical energy storage device, comprising a plurality of microfibers (3) that are suitable for having a heat-transfer fluid pass through them, and at least two header boxes (4, 5), at least one microfiber (3) being hydraulically connected to at least one input header box (4) configured to distribute the heat-transfer fluid into the microfibers (3) and at least one output header box (5) configured to collect the heat-transfer fluid that leaves the microfibers (3), the input header box (4) and/or the output header box (5) being configured to be fitted around at least a portion of the electric charging cable (2).

The present invention relates to the field of electric charging of electrical energy storage devices of electric or hybrid thermal-electric motor vehicles. More particularly, the invention relates to electric charging cables for such electrical energy storage devices that are susceptible to heating during the vehicle charging operation.

In the automotive field, current environmental constraints encourage automotive manufacturers to develop the market for electric and hybrid vehicles, which are less polluting emissions than conventional heat engine vehicles.

These electric and hybrid vehicles are propelled by means of an electric motor powered by electrical energy stored in batteries arranged in the vehicle. The batteries are refueled by connecting the electric vehicle to a charging station via an electric charging cable. In order to reduce the time required to recharge these batteries, new apparatus have been set-up in order to allow a “fast charge” or “ultra fast charge” for these batteries, i.e., a full charge, or almost full charge, in a few tens of minutes. Thanks to this high-power charging technology and high current intensity, recharging an electric vehicle is comparable to refueling a heat engine.

During these rapid charging phases, the charging cables are subjected to high stresses, in particular high temperatures. These temperature rises risk damaging the electric charging cables as well as the connection elements, such as adapter plugs, or risk endangering the user who has to grip and handle the charging cables.

In order to lower the temperature of the charging cables, a known solution consists in increasing the section of the current conducting elements of the electric charging cable. This solution has at least the disadvantage of reducing the flexibility and handling of the cable, especially by increasing its size and weight.

Another solution consists in connecting cooling systems to the electric charging cables. Electric charging cables are known to be equipped with cooling fluid circulation lines that follow the current-carrying elements of the cables or are contained within them in order to cool them by dissipating the heat generated. These cooling systems are not sufficiently efficient in relation to the amount of heat generated during ultra fast charging.

The invention forms part of this context and aims to improve the performance and reliability of electric or hybrid vehicle charging cables as well as to improve the safety of users handling them. To this end, the invention proposes solutions for increasing the absorption and dissipation of heat generated in electric charging cables during the refueling operations of electrical energy storage devices, particularly in the case of ultra fast charging.

The invention proposes a cooling element for an electric charging cable of an electrical energy storage device, such as an electric battery, capable of ensuring optimal thermal regulation of the electric charging cable throughout the process in which it is refueled with electricity. Said cooling element has the advantage of having a very large heat exchange surface, which makes it possible to significantly reduce the sectional dimensions of the current-conducting elements of the electric charging cable and thus to reduce their size and weight.

The invention firstly relates to a cooling element for an electric charging cable of an electrical energy storage device comprising a plurality of microfibers that are suitable for having a heat-transfer fluid pass through them, and at least two header boxes, at least one microfiber being hydraulically connected to at least one input header box configured to distribute the heat-transfer fluid into the microfibers and at least one output header box configured to collect the heat-transfer fluid that leaves the microfibers, the input header box and/or the output header box being configured to be fitted around at least part of the electric charging cable.

Hereinafter, the expression “heat-transfer fluid” means a fluid for transporting calories and for exchanging calories with its environment, i.e., for giving up or collecting calories, this heat exchange resulting or not in a change of state of the heat-transfer fluid. In this case, the heat-transfer fluid circulating in the microfibers is configured to capture the calories emitted by the electric charging cable during operation, i.e., during the electric charging operations of the electric batteries, so as to lower the temperature of said charging cable. The fluid can be a refrigerant, for example of the 1234yf or CO2 type, a mixture of glycol and water, or any other fluid suitable for this use.

The term “hydraulically connected” shall be understood to mean that each microfiber of the cooling element is in fluid communication with the input header box and also with the output header box.

According to a series of features of the cooling element according to the invention, which may be taken alone or in combination, it is provided that:
the microfibers are hollow structures with a constant, or approximately constant, section;
a section of each microfiber has a main dimension between 0.1 mm and 1.5 mm, advantageously between 0.4 and 1 mm, even more advantageously between 0.5 and 0.7 mm

The term “main dimension” means the longest dimension of the section of the microfiber in question. By way of an example, when the microfiber has a circular section, the diameter of the section is called the “main dimension”. Likewise, when the microfiber has a substantially rectangular section, the term “main dimension” is understood to mean a diagonal of this section.

According to another set of features of the cooling element according to the invention that may be taken alone or in combination, it is provided that the microfibers are made of at least one polymer material.

Advantageously, the use of the polymer material gives the microfibers sufficient mechanical strength and chemical resistance to withstand the stresses to which they are subjected.
each microfiber has at least a first end hydraulically connected to the input header box and at least a second end hydraulically connected to the output header box;
the first ends of the microfibers are connected to the input header box so as to form a circular profile;
the second ends of the microfibers are connected to the output header box so as to form a circular profile;
a non-zero distance is provided between two successive microfibers in at least one of the header boxes. For example, this non-zero distance between each microfiber is between 0.5 and 3 mm.
the cooling element comprises at least one heat-transfer fluid return pipe which extends between a first end hydraulically connected to the output header box and a second end hydraulically connected to a cooling circuit configured to thermally treat the heat-transfer fluid circulating in the microfibers;
the heat-transfer fluid return pipe is arranged at a non-zero distance from each microfiber. For example, this non-zero distance is between 0.5 and 3 cm.
the return pipe comprises at least one thermally insulating material. For example, this thermally insulating material may be a rubber, EPDM, polyurethane or any other material deemed suitable for this purpose.
the input header box has at least a first lug in which there is provided an orifice, said orifice being suitable for allowing hydraulic connection of the input header box to a cooling circuit configured to thermally treat the heat-transfer fluid circulating in the microfibers;
the input header box comprises at least a second lug in which there is provided a recess suitable for being passed through by the heat-transfer fluid return pipe. In other words, it is understood that the hydraulic connection between the return pipe and the cooling circuit is made downstream of the input header box, the term “downstream” being defined in relation to the direction of circulation of the heat-transfer fluid in the return pipe. Alternatively, the input header box comprises at least a second lug in which there is provided a recess suitable for being hydraulically connected to the heat-transfer fluid return pipe on the one hand and to the cooling circuit on the other hand. In other words, it is understood that, according to this alternative, the return pipe of the heat-transfer fluid is hydraulically connected to the recess provided in the second lug, i.e., it opens out into this recess, and that this recess is in turn hydraulically connected to the cooling circuit, and sealed from the rest of the input header box;
The second lug of the input box is suitable on the one hand for being connected to an external cooling circuit, and on the other hand is suitable for being passed through by the return pipe and/or attached to said return pipe and has a channel acting as a fluid connection between the return pipe and the cooling circuit, said channel passing through the second lug being fluid-tight with the rest of the input header box; in other words, the input header box is separated into a first fluidic compartment for conducting fluid from the first lug to the microfibers, and a second compartment for conducting fluid from the return pipe to the output and thus to the cooling circuit;
the output header box acts as a return box in the sense that it collects the fluid coming from the microfibers and returns it to the input box through the second lug, then through the return pipe, attached to the second lug of the output box;
the input header box and the output header box are structurally identical. Advantageously, such structural identity allows for economies of scale to be provided in the production of these input and output header boxes. For example, both the input and the output header box comprise the first lug and the second lug in which the orifice and the recess are formed, respectively. According to this example, the orifice formed in the first lug of the input header box is fluidically connected to the cooling circuit, the recess in the second lug of the input header box is fluidically connected to the return pipe or passed through by the return pipe, the orifice in the first lug of the output header box is fluidically connected to the microfibers, and the recess formed in the second lug of the output header box is closed, for example by a plug.

The invention also relates to an electric charging cable for an electrical energy storage device of a motor vehicle comprising a plurality of electrically conductive elements assembled together to form a conductive core, at least one cooling element as previously described and at least one outer sheath housing at least the conductive core and at least part of the cooling element.

The expression “conductive core” means a portion of the cable that conducts electrical energy. Advantageously, the outer sheath makes it possible to protect the microfibers from external aggression, thus ensuring their integrity and extending the life of the electric charging cable equipped with these microfibers.

Furthermore, it is understood that the heat-transfer fluid circulating in the microfibers is configured to capture calories emitted by the conductive core.

According to a series of features of the electric charging cable according to the invention, which may be taken alone or in combination, it is provided that:
each microfiber of the cooling element extends in a main direction parallel to an elongation axis of the conductive core;
each microfiber of the cooling element is wound in a helical coil coaxial to the axis of elongation of the conductive core. Advantageously, the microfiber winding has a regular winding pitch. The term “winding pitch” means a distance measured between two successive turns of the same microfiber;
the microfibers can be wound so as to be in contact in pairs along the main direction of extent of the microfibers. Advantageously, the microfiber winding forms a uniform microfiber layer. The term “uniform layer” herein means that the layer of microfibers formed has a constant thickness along the entire main direction of extent. Advantageously, such a configuration makes it possible to arrange a maximum number of microfibers around the conductive core, thus increasing the available exchange surface. Alternatively, a non-zero distance can be provided between two successive microfibers. Advantageously, such a spacing makes it possible to avoid, or at least to limit, a heat transfer between the heat-transfer fluid circulating in two successive turns of microfibers. In other words, this distance improves the efficiency of heat transfer between the heat-transfer fluid and the conductive core.

According to a first embodiment of the electric charging cable, it is provided that at least part of the cooling element is interposed between the conductive core and the outer sheath of the electric charging cable. In other words, according to this first embodiment, the cooling element is arranged outside the conductive core. For example, the microfibers that participate in forming the cooling element can be wrapped around the conductive core. The advantage of this first embodiment is that the cable temperature at the periphery of the cable is as low as possible. This arrangement makes it possible to greatly limit the risk of burns or of excessive heat sensation for the user handling said cable.

According to a second embodiment of the electric charging cable, it is provided that the conductive core is interposed between at least part of the cooling element and the outer sheath. In other words, it is understood that the cooling element is arranged, at least in part, inside the conductive core, i.e., that at least the microfibers which participate in forming this cooling element are surrounded by the electrically conductive elements constituting the conductive core. The advantage of this second embodiment is that the conductive core is better cooled.

According to a third embodiment of the electric charging cable, it is provided that the cable is formed by a joint winding of the electrically conductive elements and the microfibers forming the cooling element.

According to another series of features of the electric charging cable according to the invention, which may be taken alone or in combination, it is provided that:
the outer sheath comprises at least one thermally insulating material. For example, the outer sheath is made of a rubber material, EPDM, polyurethane or any other material deemed suitable for this purpose. Advantageously, such a sheath avoids heat loss to the surrounding environment. In other words, the outer sheath made of thermally insulating material makes it possible to maintain an optimum temperature difference between the heat-transfer fluid circulating in the microfibers and the conductive core;
the axis of elongation of the conductive core passes through a center of the circular shape in which the microfibers are arranged on the input header box and through a center of the circular shape in which the microfibers are arranged on the output header box;
the input header box and/or the output header box are arranged, at least partially, around the conductive core of the electric charging cable;
the heat-transfer fluid return pipe extends along a main extension line parallel to the axis of elongation of the conductive core of the electric charging cable.

The invention further relates to an electrical power distribution device configured to enable recharging of at least one electrical energy storage device, comprising at least one electric charging cable as previously described.

According to a feature of the electrical power distribution device according to the invention, it is provided that it comprises at least one electrical supply member, at least the conductive core of the electric charging cable being electrically connected to this electrical supply member.

According to another feature of the electrical power distribution device according to the invention, it is provided that it comprises a cooling circuit intended to cool the heat-transfer fluid circulating in the microfibers of the network of microfibers of the cooling element of the electric charging cable, the cooling circuit comprising the cooling element of the electric charging cable and at least one heat exchanger configured to discharge the heat-transfer fluid of its calories. For example, the cooling circuit comprises at least one compression member suitable for increasing the pressure of the heat-transfer fluid passing through it, the at least one heat exchanger, and at least one expansion member configured to decrease a pressure of the heat-transfer fluid leaving the at least one heat exchanger, the heat exchanger being configured to effect a heat exchange between the compressed heat-transfer fluid and a heat-transfer fluid.

The invention further relates to a method for placing the cooling element on an electric charging cable as previously described, said method comprising at least:
a first step of placing the cooling element around the conductive core, so that each microfiber extends along a main extension axis parallel to the elongation axis of the conductive core;
a second step of rotating the cooling element around the conductive core so that the microfibers are wrapped around the conductive core;
a third step of blocking the cooling element so as to maintain the microfibers in the winding position;
a fourth step of placing an outer sheath around at least part of the cooling element.

According to a feature of the method, the step of placing the cooling element is done by fitting said cooling element around the conductive core.

The method of placing an electric charging cable may further include steps of manufacturing the header boxes, said manufacturing steps comprising at least:
a step of placing a plurality of microfibers that participate in forming a cooling element in a first mold so that a non-zero distance separates each microfiber;
a step of forming a first part of the input header box and a first part of the output header box by means of the first mold in which the microfibres intended to form, at least in part, the cooling element are arranged, and of forming a second part of the input header box and a second part of the output header box in a second mold which may or may not be separate from the first mold;
a step of cutting the first part of the input header box and the first part of the output header box so as to open the microfibers around which these first parts of the input and output header boxes are molded;
a step of assembling the second part of the input header box with the first part of this input header box and the second part of the output header box with the first part of this output header box.

According to one embodiment of the assembly step, the first part of the input header box may be crimped to the second part of the input header box and the first part of the output header box, for its part, may be crimped to the second part of the output header box.

According to another embodiment, the first and second parts of the input header box, as well as the first and second parts of the output header box, can be joined together by glue or by any other fixing means with a sealing device between said first and second parts of each header box.

Other features and advantages of the invention will become more clearly apparent upon reading the detailed description of embodiments of the invention, which are given below by way of illustrative and non-limiting example and with reference to the appended figures, in which there is illustrated a cooling element for an electric charging cable for an electrical energy storage device according to the invention and in which:

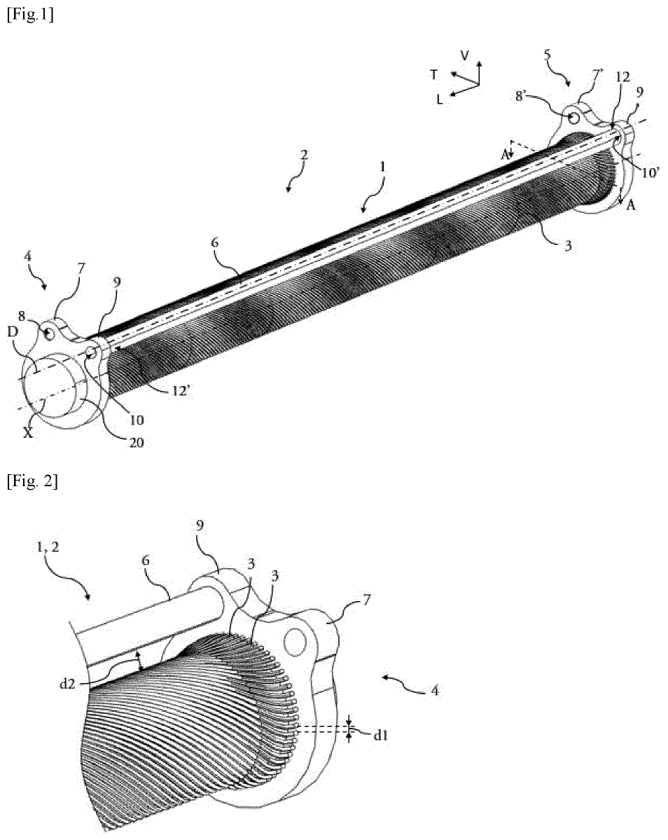

FIG. 1 is a perspective side view of a first embodiment of an electric charging cable acording to the invention;

FIG. 2 is a detail view of one end of the electric charging cable according to the first embodiment of the invention;

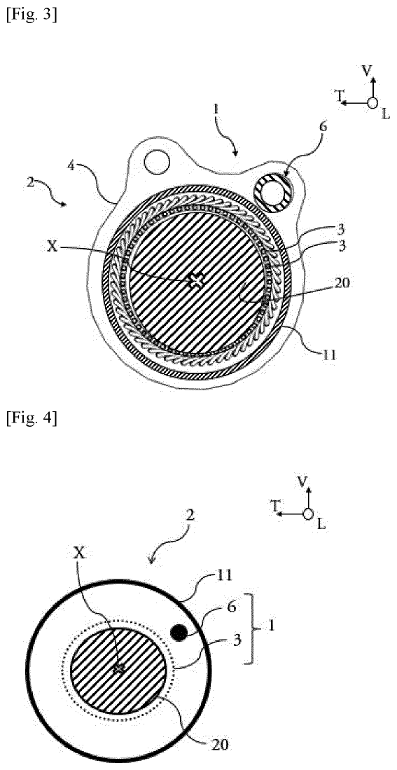

FIG. 3 is a sectional view of the electric charging cable according to a first variant of the first embodiment of the invention, the electric charging cable comprising a cooling element according to the invention;

FIG. 4 is a schematic view in cross section of the electric charging cable according to a second variant of the first embodiment of the invention;

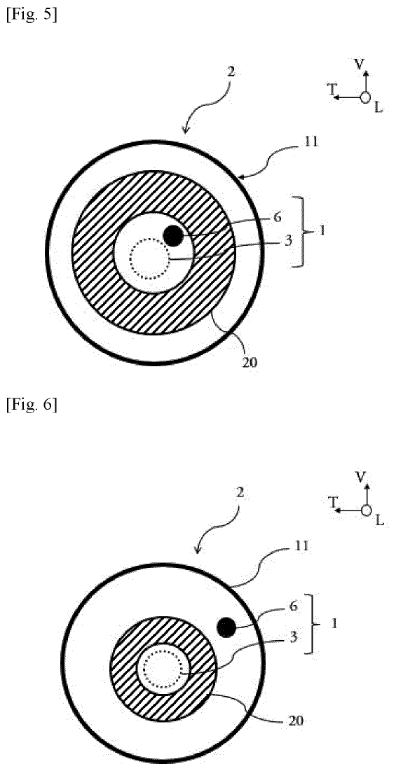

FIG. 5 is a schematic view in cross section of the electric charging cable comprising the cooling element according to a first variant of a second embodiment of the invention;

FIG. 6 is a schematic sectional view of the electric charging cable comprising the cooling element according to a second variant of the second embodiment of the invention;

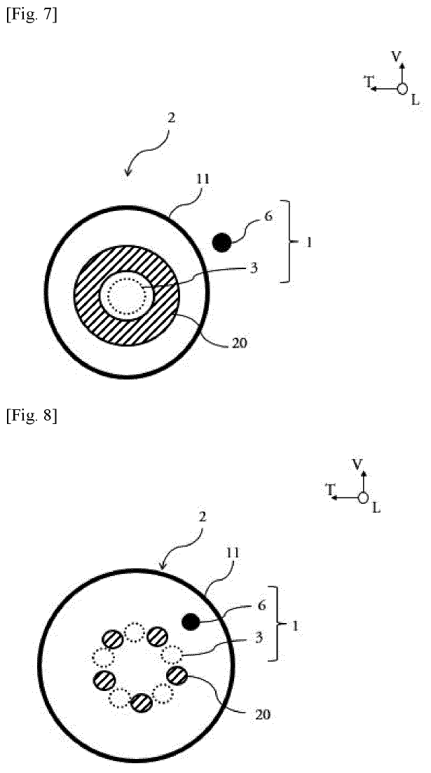

FIG. 7 is a schematic view in cross section of the electric charging cable comprising the cooling element according to a third variant of the second embodiment of the invention;

FIG. 8 is a schematic view in cross section of the electric charging cable comprising the cooling element according to a third embodiment of the invention;

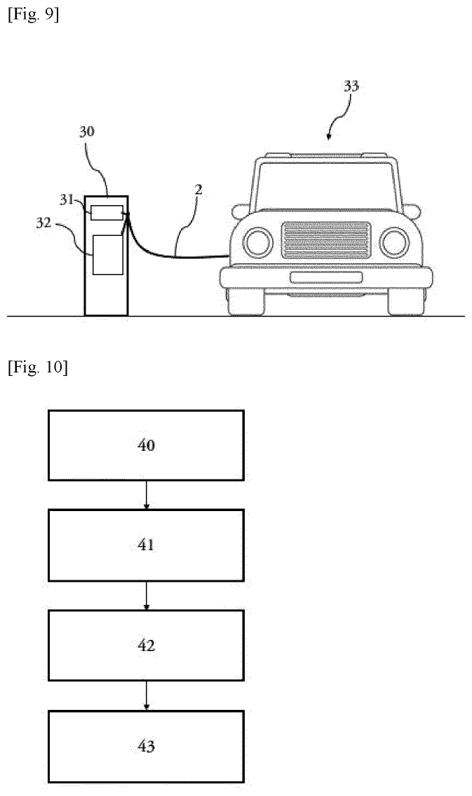

FIG. 9 is a schematic view of an electrical power distribution device comprising at least one electric charging cable according to the invention;

FIG. 10 illustrates, in the form of a block diagram, a method for manufacturing the electric charging cable according to the invention.

Although the figures set out the invention in detail for its implementation, they may, of course, be used to better define the invention if necessary. Likewise, it must be remembered that, across all of the figures, the same elements are denoted by the same references. It will also be understood that the embodiments of the invention illustrated in the figures are given by way of non-limiting examples.

In the figures, the terms longitudinal, transverse, lateral, left, right, above and below refer to the orientation, with reference to a trihedron L, V, T, of an electrical charging cable 2 according to the invention. Within this frame of reference, a longitudinal axis L represents a longitudinal direction, a transverse axis T represents a transverse direction, and a vertical axis V represents a vertical direction of the object in question. Within this frame of reference, a cross section corresponds to a section taken in a transverse and vertical plane, that is to say in a plane in which the transverse axis T and the vertical axis V of the trihedron are inscribed. In the following description, the terms “electric charging cable” and “charging cable” will be used interchangeably.

The following description relates to a cooling element according to the invention used to provide thermal regulation of an electric charging cable intended for electrically charging an electrical energy storage device of a vehicle or hybrid thermal-electric vehicles, but it should be understood that this is only a particular example of an application of the present invention which does not limit the invention. It will thus be possible to provide for the use of the cooling element according to the invention for the thermal regulation of any known electric charging cable.

FIG. 1 illustrates an electrical charging cable 2 according to a first embodiment of the invention of an electrical energy storage device, of the battery type, suitable, in particular, for being fitted in an electric or hybrid motor vehicle (not shown) and intended to supply power to an electric motor fitted to said motor vehicle for the purpose of moving it. Such an electric charging cable 2 comprises a plurality of electrically conductive elements, not shown here, assembled together to form a conductive core 20. This conductive core 20 extends along a main axis of elongation X parallel to the longitudinal axis L of the illustrated trier, and forms the portion of the electric charging cable 2 that conducts the electrical energy. The electric cable 2 further comprises an outer sheath illustrated in FIGS. 3 to 8, which will be described in greater detail with reference to those figures.

During battery refueling operations, especially during ultra fast charging, the electric charging cable 2, and more particularly the conductive core 20 of this electric charging cable 2, tends to heat up strongly. In order to remove the heat generated in the electric charging cable, it is necessary to provide the charging cable structure with an effective cooling system. Therefore, a cooling element 1 according to the invention equips the electric charging cable 2, the function of this cooling element being to regulate the temperature of said charging cable 2, in particular by absorption and dissipation of the heat generated in the conductive core 20 of this charging cable 2.

According to any one of the embodiments of the invention, the cooling element 1 comprises a plurality of microfibers 3 suitable for having pass through them a heat-transfer fluid configured to capture calories emitted by the electric charging cable 2 during operation, i.e., during electric charging operations of the electric batteries, in order to lower the temperature of said electric charging cable 2. The cooling element 1 also comprises an input header box 4 to which each microfiber 3 is hydraulically connected by a first end and an output header box 5 to which each microfiber 3 is hydraulically connected by a second end.

The input header box 4 is configured to distribute the heat-transfer fluid into each microfiber 3 while the output header box 5 is configured to collect the heat-transfer fluid from each microfiber 3. The input header box 4 and output header box 5 are configured to be fitted around at least part of the electric charging cable 2. According to the example shown in FIG. 1, the header boxes 4, 5 are more particularly fitted around the conductive core 20 of the charging cable 2.

Hereafter, unless otherwise indicated, the designations “upstream” and “downstream” will be defined in relation to the direction of circulation of the heat-transfer fluid in each microfiber 3, said heat-transfer fluid being introduced, at the input of each microfiber, by means of the input header box 4 and then collected, at the output of each microfiber, by the output header box 5.

According to the invention, each microfiber 3 is a hollow structure of constant, or substantially constant, section. Each microfiber 3 has a section with a main dimension that ranges between 0.1 mm and 1.5 mm. The term “main dimension” is understood to mean the longest dimension of the section of the relevant microfiber 3. By way of an example, when the microfiber has a hollow tube structure with a circular section, the diameter of the section is called the “main dimension”. Likewise, when the microfiber has a substantially rectangular section, the term “main dimension” is understood to mean a diagonal of this section.

Advantageously, each microfiber 3 has a main dimension of less than 1 mm

These microfibers 3 are made of polymer material.

Advantageously, the use of such a material imparts each microfiber 3 with sufficient mechanical strength and chemical resistance for withstanding the stresses to which they are subjected, in particular the stresses related to temperature variations and to the circulation of the heat-transfer fluid. Furthermore, such a material allows the microfibers to be imparted with elasticity and flexibility features, so that they can be deformed without affecting their integrity. Advantageously, this deformability makes it possible to rotate the microfibers so as to wind them, for example, around the conductive core 20 of the electric charging cable 2. In other words, and as will be more fully detailed in the remainder of the description, this deformability makes it possible to arrange the microfibers 3 in which the heat-transfer fluid circulates as close as possible to the conductive core 20 of the electric charging cable 2, so as to allow the capture and dissipation of as many calories as possible.

As shown, the cooling element 1 also includes a heat-transfer fluid return pipe 6 hydraulically connected by a first end 12 to the output header box 5 and by a second end 12′ to a cooling circuit configured to thermally treat the heat-transfer fluid circulating in the microfibers 3. This return pipe 6 extends along a main extension line D parallel to the axis of elongation X of the conductive core 20 of the electric charging cable 2. Advantageously, the return pipe 6 can be made of a thermally insulating material, so that the calories captured by the heat-transfer fluid circulating in this return pipe 6 do not dissipate again into the immediate environment of the electric charging cable 2.

The input header box 4 has a first lug 7 in which there is formed an orifice 8 and a second lug 9 in which there is formed a recess 10. According to a first arrangement, the orifice 8 of the first lug 7 is suitable for allowing the hydraulic connection of the input header box 4 to the cooling circuit configured to thermally treat the heat-transfer fluid circulating in the microfibers 3, and the recess 10 formed in the second lug 9 is suitable for being passed through by the heat-transfer fluid return pipe 6. According to this first arrangement, the hydraulic connection between the return pipe 6 and the cooling circuit is made upstream of the input header box 4. In other words, the hydraulic connection between the return pipe 6 and the cooling circuit is made, according to this configuration, downstream of the input header box 4, with respect to a direction of flow of the heat-transfer fluid in this return pipe 6. According to a second arrangement of the cooling element 1, the recess 10 of the second lug 9 of the input header box 4 is suitable for being hydraulically connected to the return pipe 6 of the heat-transfer fluid on the one hand and to the cooling circuit on the other hand. In other words, according to this second arrangement, the heat-transfer fluid, charged with the calories captured during its passage through the microfibers 3, transits through the input header box 4 before joining the cooling circuit.

Advantageously, the input header box 4 and the output header box 5 are structurally identical, i.e., the output header box 5 also comprises a first lug 7′ in which there is formed an orifice 8′ and a second lug 9′ in which there is formed a recess 10′. According to any one of the above-described arrangements, the orifice 8′ formed in the first lug 7′ of the output header box 5 is hydraulically connected to the return pipe 6, while the recess 10′ formed in the second lug 7′ of the output header box 5 is kept closed, for example by obstruction with a plug.

Advantageously, such a structural identity allows for significant economies of scale in the production of these header boxes.

It will be understood that this is merely an exemplary embodiment, and that the output header box 5 could simply be devoid of its second lug without departing from the scope of the present invention.

Each microfiber 3 of the cooling element 1 extends along a main direction of extent parallel to the elongation axis X of the conductive core 20. As shown, each of these microfibers 3 is wound in a helical winding coaxial to the elongation axis X of the conductive core 20. In other words, the main direction of extent of the microfiber winding 3 is parallel to the elongation axis X of the conductive core 20. Advantageously, the microfiber winding 3 has a regular winding pitch. The winding pitch corresponds to a distance measured between two successive microfibers 3.

For example, the microfibers 3 can be wound so that they are in contact in pairs along the main direction of extension of the microfibers 3. Such a winding of the microfibers 3, advantageously makes it possible to arrange a maximum number of microfibers 3 around the conductive core 20 and thus to increase the available exchange surface. The contact surface, obtained by the contact of the microfibers 3 with each other, makes it possible to create a maximum heat exchange surface between the heat-transfer fluid circulating in the microfibers 3 and the conductive core 20. As a result, the thermal regulation of the conductive core 20 throughout the process of charging the electrical energy storage device with electricity is optimized and leads to the cooling of the electric charging cable 2. Such an arrangement makes it possible to significantly reduce the sectional dimensions of the current-carrying elements of the electric charging cable 2 and thus to reduce their size and weight.

Alternatively, a non-zero distance can be provided between two successive microfibers 3. Advantageously, such a spacing makes it possible to avoid, or at least to limit, a heat transfer between the heat-transfer fluid circulating in two successive turns of microfibers. In other words, this distance improves the efficiency of heat transfer between the heat-transfer fluid and the conductive core 20.

Furthermore, it is intended that the microfiber winding 3 forms a uniform layer of microfibers, i.e., a layer of constant thickness along the entire main direction of extent of the microfibers 3.

FIG. 2 is an enlargement of a portion of the charging cable 2, provided at the input header box 4. As illustrated, the microfibers 3 are arranged on and connected to this input header box 4 in a circular profile. More precisely, the first ends of each microfiber 3 are connected to the input header box 4 so as to form a circular profile. Advantageously, the microfibers 3 are also arranged and connected to the output header box in a circular profile. Likewise, the second ends of each microfiber are connected to the output header box forming a circular profile. Each circular arrangement of the ends of the microfibers is made in such a way that a non-zero distance d₁ is provided between two successive microfibers. Preferably, such a distance d₁ is between 0.5 and 3 mm. Advantageously, the circular profile of the first ends of the microfibers 3 and the circular profile of the second ends of the microfibers 3 are identical to each other.

Furthermore, the return pipe 6 is arranged at a non-zero, preferably substantially constant, distance d₂ from each microfiber 3 so as to extend parallel to the main direction of extent of the structure formed by the plurality of microfibers 3. Preferably, such a distance d₂ is between 0.5 and 3 cm.

FIGS. 3 to 8 illustrate the electric charging cable 2 of an electrical energy storage device of a motor vehicle according to three distinct embodiments of the invention. More particularly, these figures depict the charging cable 2 as viewed in cross section.

As previously mentioned, and regardless of the embodiment of the electric charging cable 2, the latter comprises a common structure formed of the plurality of electrically conductive elements (not shown) assembled together to form the conductive core 20, at least one cooling element 1 as previously described, and at least one outer sheath 11 housing at least the conductive core 20 and at least part of the cooling element 1, in this case at least the microfibers 3 of this cooling element 1. Each electrically conductive element is made of a conductive metal, for example copper or copper alloy, which has a high electrical conductivity. Advantageously, the outer sheath 11 makes it possible to protect, at least, the microfibers 3 mechanically, i.e., this sheath 11 prevents these microfibers 3 from deteriorating, thus improving the service life of the cooling element 1, and thus also of the charging cable 2 to which it is fitted. For example, this outer sheath 11 may comprise at least one thermally insulating material, so as to avoid heat loss to the surrounding environment and to maintain an optimum temperature difference between the heat-transfer fluid circulating in the microfibers 3 received in this outer sheath 11 and the conductive core 20.

Within the conductive core 20, the electrically conductive elements can be arranged with each other in any known manner. In other words, the conductive core 20 may be formed of electrically conductive elements arranged individually or in bundles, in one or more layers, so as to constitute any type of geometric arrangement forming at least one conductive strand.

FIG. 3 illustrates, according to a cross section made along the plane AA illustrated in FIG. 1, a first variant of the first embodiment of the invention according to which the cooling element 1, formed, at least, by the plurality of microfibers 3 and the return pipe 6, is interposed between the conductive core 20 and the outer sheath 11 of the cable 2. In this configuration, the plurality of microfibers 3 is wound around the conductive core 20, on the outside thereof. This first embodiment has the advantage of making it possible to obtain the lowest possible temperature of the electric charging cable 2 at its periphery and thus to greatly limit the risks of burns or of a sensation of excessive heat for the user handling said electric charging cable 2.

Furthermore, according to this first embodiment, the axis of elongation X of the conductive core 20 passes through a center of the circular shape according to which the microfibers 3 are arranged on the input header box 4 and through a center of the circular shape according to which the microfibers 3 are arranged on the output header box. Furthermore, as illustrated in FIG. 1, the input header box 4 and/or the output header box are arranged, preferably fitted, around the conductive core 20 of the electric charging cable 2.

According to this first variant of the first embodiment, the return pipe 6 is arranged outside the outer sheath 11. In other words, according to this variant of the first embodiment, this outer sheath only receives the conductive core 20 and the microfibers 3.

FIG. 4 illustrates, schematically and according to a cross section made in the same plane AA illustrated in FIG. 1, a second variant of the first embodiment. In order to facilitate the reading of the figures, neither of the header boxes is illustrated in this FIG. 4. The second variant of the first embodiment differs from the first variant just described in that the return pipe 6 is included in the outer sheath 11. In other words, this outer sheath 11 receives both the conductive core 20, the microfibers 3 and the return pipe 6.

FIGS. 5, 6 and 7 illustrate, respectively, a first variant, a second variant and a third variant of a second embodiment of the invention. More particularly, these figures illustrate the charging cable 2 seen in cross section and without its collector boxes.

According to any one of the variants of the second embodiment illustrated, the conductive core 20 is interposed between at least part of the cooling element 1 and the outer sheath 11. It is understood that, in this embodiment, the microfibers 3 are initially positioned inside the conductive core 20, i.e., in the center of the conductive core 20, before being able to be connected, by their first and second ends, to the input and output header boxes, respectively, for example in such a way as to form the circular profile previously mentioned. This second embodiment, according to which the cooling element 1 is inside the conductive core 20, has the advantage of allowing a better cooling of said conductive core.

According to the first variant of this second embodiment illustrated in FIG. 5, the return pipe 6 is arranged in the center of the conductive core 20. In other words, according to this first variant, both the microfibers 3 and the return pipe 6 are arranged in the center of the conductive core 20.

According to the second variant of the second embodiment illustrated in FIG. 6, the return pipe 6 is arranged between the conductive core 20 and the outer sheath 11.

According to the third variant of the second embodiment shown in FIG. 7, the return pipe 6 is arranged outside the outer sheath 11. According to this third variant of the second embodiment, only the conductive core 20 and the microfibers 3 are thus received and protected by the outer sheath 11.

FIG. 8 illustrates a third embodiment of the invention according to which the charging cable 2 is formed by a joint winding of the electrically conductive elements forming the conductive core 20 and the microfibers 3 which participate in forming the cooling element 1. According to the example illustrated in FIG. 8, the outer sheath 11 accommodates both the conductive core 20, the microfibers 3 and the return pipe 6. It is understood that the return pipe 6 could be arranged outside this outer sheath 11 without departing from the scope of the present invention.

The electric charging cable 2, as just described, is intended to equip an electrical energy distribution device 30 configured to allow the recharging of at least one electrical energy storage device, for example of a vehicle 33 with an electric or hybrid motor. Such an electrical energy distribution device 30 is illustrated for example very schematically in FIG. 9. More particularly, FIG. 9 illustrates an exemplary embodiment of the invention in which the electrical energy distribution device 30 is used to recharge the electrical energy storage device of a motor vehicle, but it is understood that this is only an exemplary embodiment and that the electrical energy distribution device according to the invention could be used for other purposes without departing from the scope of the present invention.

In the remainder of the description, the terms “electrical energy distribution device” and “distribution device” will be used synonymously.

The distribution device 30 comprises at least the electric charging cable 2 as previously described and an electrical supply member 31 electrically connected to the electric charging cable 2. More particularly, the electrical supply member 31 is electrically connected to the conductive core 20 of the electric charging cable 2.

In addition, the electrical power distribution device 30 comprises the cooling circuit 32 intended for cooling the heat-transfer fluid flowing through the plurality of microfibers of the cooling element of the electric charging cable 2.

According to the invention, the cooling circuit 32 comprises at least one heat exchanger suitable for allowing the heat-transfer fluid that joins it to be discharged from the calories captured in the immediate environment of the conductive core of the electric charging cable 2, i.e., to cool this heat-transfer fluid. This heat exchanger can, for example, be configured to operate an exchange between the heat-transfer fluid circulating in the microfibers and a flow of air, or between the heat-transfer fluid and a heat-transfer fluid without departing from the scope of the invention. The term “heat-transfer fluid” herein is understood to mean a fluid capable of transporting and exchanging calories with its environment by changing or not changing state.

According to an exemplary embodiment of the invention, the cooling circuit 32 may comprise at least one compression member suitable for increasing the pressure of the heat-transfer fluid passing through it, at least the heat exchanger referred to above, and at least one expansion member configured to lower the pressure of the heat-transfer fluid. According to this exemplary embodiment of the invention, the heat-transfer fluid joins the microfibers through the input header box, picks up calories emitted by the conductive core of the charging cable 2, and then joins the output header box through the return pipe. This heat-transfer fluid can then transit through this output header box, or not, before joining the compression member, where it is compressed. The heat-transfer fluid, at high pressure and heated by its passage through the microfibers of the cooling element of the charging cable 2, then joins the heat exchanger, where it transfers calories to some other kind of fluid. Once it has been discharged of its calories, the heat-transfer fluid passes through the expansion member, where its pressure is reduced to allow it to return to the input header box and then to start a new thermodynamic cycle by joining the microfibers of the cooling element of the charging cable 2 again.

FIG. 7 illustrates, in the form of a flow chart, a process for placing the cooling element to form the electric charging cable as described above.

The process comprises at least:
a first step 40 of placing the cooling element around the conductive core, so that each microfiber extends along a main line of extent parallel to the axis of elongation of the conductive core. For example, this first step of placing the cooling element can be done by fitting the cooling element, i.e., the plurality of microfibers and the input and output collector boxes to which the microfibers are hydraulically connected, around the conductive core;
a second step 41 of rotating the cooling element around the conductive core so that the microfibers are wrapped around the conductive core 2;
a third step 42 of blocking the cooling element so as to maintain the microfibers in the winding position;
a fourth step 43 of placing the protective insulating outer sheath at least around the microfiber winding.

It is understood that, regardless of the embodiment of the cooling element and of the electric charging cable, the step of rotating the cooling element makes it possible, on the one hand, to provide the helical winding coaxial to the axis of elongation of the conductive core and, on the other hand, to bring the microfibers closer to each other until they are in contact with each other with the aim of creating a maximum available heat exchange surface. Alternatively, the step of rotating the cooling element can be shortened so that the microfibers are brought closer together to form the helical winding, but without the microfibers being in contact with each other.

According to another embodiment of the method for placing the electric charging cable, the step of placing the cooling element may consist of arranging said cooling element inside the conductive core, so that each microfiber extends along a main line of extent parallel to the elongation axis of the conductive core. In another embodiment, the microfibers are first positioned relative to the conductive core and are then connected to the input and output header boxes.

The method of placing the cooling element around the electric charging cable may further include steps of manufacturing the header boxes comprising at least:
a step of placing a plurality of microfibers intended for forming, in part, the cooling element in a first mold so that a non-zero distance separates each microfiber;
a step of forming a first part of the input header box and a first part of the output header box by means of the first mold in which the microfibres intended to form the cooling element are arranged, and of forming a second part of the input header box and a second part of the output header box in a second mold which may or may not be separate from the first mold;
a step of cutting the first part of the input header box and the first part of the output header box so as to open the microfibers around which these first parts of the input and output header boxes are molded;
a step of assembling the second part of the input header box with the first part of this input header box and the second part of the output header box with the first part of this output header box.

According to an exemplary embodiment of the assembly step, the first and second parts of the input and output header box, respectively, can be assembled to each other by crimping or by gluing or by any other fixing means with a sealing device between said two first and second parts of each of the input and output header boxes, respectively.

Furthermore, in the second embodiment of the invention, according to which the cooling element is arranged inside the conductive core, the microfibers are first positioned with respect to the conductive core and then, in a second step, are connected to the input and output header boxes.

The foregoing description clearly explains how the invention makes it possible to achieve its objectives and in particular to propose a cooling element for an electric charging cable of an electrical energy storage device, said cooling element having the objective of improving the performance and reliability of the electric charging cable, while making it safer to handle, by improving the thermal regulation of said electric charging cable by capturing and dissipating the calories emitted by the latter. By proposing a cooling element having a very large heat exchange surface, the invention makes it possible to significantly lower the temperature of the electric charging cable throughout the electricity refueling process. The risk of damage to the charging cable and other connection elements is therefore greatly reduced and the efficiency of the high-power, ultra fast charging technology is improved. The efficient cooling of the electric charging cable also significantly reduces the sectional dimensions of the current-carrying elements that make up the cable, thus reducing the size and weight of said electric charging cable.

The invention is not limited to the embodiments specifically given in this document by way of non-limiting examples, and extends in particular to all equivalent means and to any technically operational combination of these means. Thus, the features, variants and various embodiments of the invention may be combined with one another, in various combinations, as long as they are not mutually incompatible or mutually exclusive. In particular, it will be possible to imagine variants of the invention comprising only a selection of the features described, provided that, in accordance with the invention, the cooling element for an electric charging cable of an electrical energy storage device comprises a plurality of microfibers suitable to have pass through them a heat-transfer fluid and hydraulically connected to at least two input and output header boxes for said heat-transfer fluid. Consequently, other configurations of the cooling element, the electric charging cable and the electrical energy distribution device according to the invention can be realized, in particular by variations in the arrangement, dimensioning and number of the elements of which they are composed, in particular the microfibers, the header boxes, the return pipe as well as the electrically conductive elements and the outer sheath.

1. A cooling element for an electric charging cable of an electrical energy storage device comprising:
a plurality of microfibers for having a heat-transfer fluid pass through them; and
at least two header boxes, at least one of the plurality of microfibers being hydraulically connected to at least one of the at least two input header boxes configured to distribute the heat-transfer fluid into the microfibers; and
at least one output header box configured to collect the heat-transfer fluid that leaves the microfibers,
the input header box and/or the output header box being configured to be fitted around at least part of the electric charging cable.

2. The cooling element as claimed in claim 1, wherein each microfiber has at least a first end hydraulically connected to the input header box and at least a second end hydraulically connected to the output header box.

3. The cooling element as claimed in claim 1, wherein the first ends of the microfibers are connected to the input header box so as to form a circular profile.

4. The cooling element as claimed in claim 2, wherein the second ends of the microfibers are connected to the output header box so as to form a circular profile.

5. The cooling element as claimed in claim 1, further comprising: at least one heat-transfer fluid return pipe which extends between a first end hydraulically connected to the output header box and a second end hydraulically connected to a cooling circuit configured to thermally treat the heat-transfer fluid circulating in the microfibers.

6. A cooling element according to claim 5, wherein the input header box has at least a first lug in which there is formed an orifice, said orifice being suitable for being hydraulically connected to the cooling circuit and to the microfibers.

7. A cooling element as claimed in claim 5, wherein the input header box comprises at least a second lug in which there is formed a recess, the recess being for being passed through by the heat-transfer fluid return pipe or for being hydraulically connected to the heat-transfer fluid return pipe on the one hand and to the cooling circuit on the other hand.

8. An electric charging cable for an electrical energy storage device of a vehicle comprising:
a plurality of electrically conductive elements assembled together to form a conductive core, at least one cooling element as claimed in claim 1; and at least one outer sheath housing at least the conductive core and at least part of the cooling element.

9. An electrical energy distribution device configured to enable recharging of at least one electrical energy storage device, comprising: at least one electric charging cable as claimed in claim 8.

10. A method for placing a cooling element as claimed in claim 1 on an electric charging cable, the method comprising:
placing the cooling element around the conductive core, so that each microfiber extends in a main direction of extent parallel to the elongation axis of the conductive core;
rotating the cooling element around the conductive core so that the microfibers are wound around the conductive core;
blocking the cooling element so as to maintain the microfibers in the winding position;
placing an outer sheath around at least part of the cooling element.
